(19) United States
(12) Patent Application Publication
(10) Pub. No.: US 2026/0039388 A1
(43) Pub. Date: Feb. 5, 2026

(54) TRANSMITTER OPTICAL SUBASSEMBLY AND OPTICAL MODULE

(71) Applicant: PIOSEED TECHNOLOGY (CHENGDU) CO., LTD., Chengdu (CN)

(72) Inventors: Huan Jiang, Chengdu (CN); Gang Chen, Chengdu (CN)

(21) Appl. No.: 19/352,478

(22) Filed: Oct. 8, 2025

Related U.S. Application Data
(63) Continuation of application No. PCT/CN2024/075263, filed on Feb. 1, 2024.

(30) Foreign Application Priority Data
Apr. 12, 2023 (CN) 202320794991.X

(51) Int. Cl. H04B 10/50; G02B 6/12

(52) U.S. Cl. CPC H04B 10/503; G02B 6/12019

(57) ABSTRACT

A transmitter optical subassembly and an optical module are provided. The transmitter optical subassembly comprises a core column, a secondary column and a first substrate. The first substrate is provided with a first conductive pattern layer, a transmitter optical chip and a matching resistor. The first conductive pattern layer comprises a radio-frequency signal transmission line, a first pad and a second pad. The transmitter optical chip is electrically connected to the first pad and the second pad respectively, the second pad is a ground pad, the matching resistor is electrically connected to the radio-frequency signal transmission line and the first pad respectively, and the matching resistor and the first pad are both provided close to the transmitter optical chip, thereby reducing a distance between the matching resistor and the transmitter optical chip.

### CROSS-REFERENCE TO RELATED PATENT APPLICATION

This application is filed as a bypass continuation under 35 U.S.C. § 111(a) and claims the benefit of International Patent Application No. PCT/CN2024/075263, filed on Feb. 1, 2024, which the international application was published on Oct. 17, 2024, as International Publication No. WO 2024/212687 A1, and claims the priority of China Patent Application No. 202320794991.X, filed on Apr. 12, 2023 in People's Republic of China. The entirety of each of the above patent applications is hereby incorporated by reference herein and made a part of this specification.

### FIELD OF THE DISCLOSURE

The present disclosure relates to the technical field of radio-on-fiber (ROF) transmission, and particularly to a transmitter optical subassembly and an optical module.

### BACKGROUND OF THE DISCLOSURE

In recent years, radio-on-fiber (ROF) technology has become increasingly popular in applications of 5G wireless small base stations. Through ROF technology, multiple base stations (BSs) can share information and control resources of a central station (CS), thereby significantly reducing energy consumption and operating costs. A relatively favorable implementation is to adopt a digital optical module packaging form to realize the function of an analog optical module. Except for the performance parameters of the radio frequency part, other parameters related to digital optical modules have existing protocols as references, which improves the compatibility of ROF technology with conventional optical communications. However, conventional analog optical technology packaged in digital optical modules is subject to bandwidth and packaging size limitations, and thus cannot meet practical requirements of ROF.

### SUMMARY OF THE DISCLOSURE

In response to the above-referenced technical inadequacies, the present disclosure provides a transmitter optical subassembly and an optical module, which are configured to optimize the electrical interface reflection of ROF and to improve the transmission performance of radio frequency signals (abbreviated as RF signals).

In order to solve the above-mentioned problems, one of the technical aspects adopted by the present disclosure is to provide a transmitter optical subassembly including a core column provided with a first bearing surface and a second bearing surface that are disposed opposite to each other, in which the core column is connected with an RF signal input pin and a bias signal input pin.

The transmitter optical subassembly further comprises a secondary column protruding from the first bearing surface of the core column, in which the secondary column is provided with a third bearing surface.

A first substrate is disposed on the third bearing surface, in which the first substrate is provided with a first conductive pattern layer, a transmitter optical chip, and a matching resistor. The first conductive pattern layer includes an RF signal transmission line, a first pad, and a second pad. The transmitter optical chip is electrically connected to the first pad and the second pad respectively, the second pad serves as a ground pad, and the matching resistor is electrically connected to both the RF signal transmission line and the first pad respectively. The matching resistor and the first pad are disposed adjacent to the transmitter optical chip. The transmitter optical subassembly further comprises a first-stage bias device, in which one end of the first-stage bias device is electrically connected to the first pad and the other end of the first-stage bias device is electrically connected to the bias signal input pin.

In some embodiments, the first-stage bias device is a planar spiral inductor element.

In some embodiments, the planar spiral inductor element is formed by a portion of the first conductive pattern layer.

Alternatively, the transmitter optical subassembly further comprises a second substrate disposed on a side of the core column with the first bearing surface. The second substrate includes a second conductive pattern layer, and the planar spiral inductor element is formed by a portion of the second conductive pattern layer.

In some embodiments, the second substrate is disposed on the first substrate.

In some embodiments, the planar spiral inductor element has a predetermined number of turns and a predetermined line width.

In some embodiments, an end portion at the center of the planar spiral inductor element is electrically connected to the bias signal input pin by a bonding wire.

Alternatively, the first conductive pattern further includes a bias signal input pad, in which the end portion at the center of the planar spiral inductor element is electrically connected to the bias signal input pad by a bonding wire.

An end portion located at the outer periphery of the planar spiral inductor element is directly connected to the first pad by an interconnection structure form by the first conductive pattern layer.

In some embodiments, the transmitter optical subassembly further comprises the following components.

A flexible printed circuit board (FPC) is disposed on a side of the second bearing surface of the core column, in which the flexible printed circuit board is electrically connected to the RF signal input pin and the bias signal input pin, respectively.

A second-stage bias device is disposed on the flexible printed circuit board, in which the second-stage bias device is cascaded with the first-stage bias device through the trace of the flexible printed circuit board and the bias signal input pin.

In some embodiments, the second-stage bias device is located on the side of the flexible printed circuit board facing away from the core column and adjacent to the position of the bias signal input pin. In some embodiments, the transmitter optical subassembly further comprises the following components.

A tuning resistor is provided, in which the tuning resistor is connected in parallel with the first-stage bias device, and the tuning resistor has a predetermined resistance value.

Further, one end of the tuning resistor is electrically connected to the first pad through a bonding wire, and the other end of the tuning resistor is electrically connected to the bias signal input pin.

In some embodiments, a reference ground layer is disposed on a surface of the first substrate away from the first conductive pattern layer, in which the reference ground layer is provided with an aperture.

The secondary column is provided with a slot on a side of the third bearing surface.

In a thickness direction of the first substrate, a projection of the planar spiral inductor element falls within a projection range of the aperture as well as within the projection range of the slot.

Optionally, the secondary column and the core column are formed as an integral metal structure.

An angle is formed between the third bearing surface and the first bearing surface.

The second pad is electrically connected to the reference ground layer, and the reference ground layer is electrically connected to the secondary column.

In some embodiments, the first substrate is a ceramic substrate.

In some embodiments, the second pad is electrically connected to the reference ground layer through a plurality of conductive vias, and the transmitter optical chip is electrically connected to the second pad through its backside ground electrode.

In some embodiments, the transmitter optical subassembly is a TO-can package.

According to another aspect of the present disclosure, an optical module is provided, in which the optical module includes any one of the transmitter optical subassemblies described above, and further comprises a module circuit board.

The module circuit board is electrically connected to the transmitter optical subassembly through a flexible printed circuit board.

Further, the optical module also includes a third-stage bias device, in which the third-stage bias device is disposed on the module circuit board. A second-stage bias device is disposed on the flexible printed circuit board. The third-stage bias device is electrically connected between the flexible printed circuit board and a constant current source, so that the bias signal is transmitted from the constant current source sequentially through the third-stage bias device, the second-stage bias device, the bias signal input pin, and the first-stage bias device, and then delivered to the transmitter optical chip.

In some embodiments, the optical module further comprises a filter component, in which the filter component is disposed in the RF signal transmission link on the module circuit board. The filter component is configured to block direct current noise in the RF signal transmission link so as to transmit alternating current RF signals. The alternating current RF signals are transmitted via the flexible printed circuit board and the RF signal input pin to the RF signal transmission line on the first substrate, and further transmitted to the transmitter optical chip through the matching resistor.

Further, the filter component includes at least one capacitor.

The present disclosure provides a solution for optimizing the electrical interface reflection of radio-on-fiber (ROF) transmission and reducing the package size of the transmitter optical subassembly. The transmitter optical subassembly includes a core column, a secondary column, and a first substrate. The first substrate is provided with a first conductive pattern layer, a transmitter optical chip, and a matching resistor. The first conductive pattern layer includes an RF signal transmission line, a first pad, and a second pad. The transmitter optical chip is electrically connected to the first pad and the second pad, the second pad serves as a ground pad, and the matching resistor is electrically connected to both the RF signal transmission line and the first pad. The matching resistor and the first pad are disposed adjacent to the transmitter optical chip, so that the distance between the matching resistor and the transmitter optical chip is minimized. As a result, the electrical interface reflection of ROF transmission is optimized to achieve optimal impedance matching, thereby reducing link signal reflection, optimizing gain flatness, and improving the transmission performance of the RF signal. At the same time, the design is more suitable for Transistor-Outline (TO) packaging.

Furthermore, the present disclosure provides a solution for expanding the coverage range of the passband and for improving the flatness of the frequency response within the passband. For example, a second-stage bias device and a third-stage bias device are cascaded with the first-stage bias device, and a tuning resistor is connected in parallel with the first-stage bias device. The tuning resistor is used to compensate for anti-resonance between the first-stage bias device and the second-stage bias device, thereby optimizing the gain flatness within the frequency band. In addition, by adopting bonding wires, high-frequency isolation can be achieved, thereby realizing both tuning and link signal reflection optimization in a unified manner.

### BRIEF DESCRIPTION OF THE DRAWINGS

In order to more clearly illustrate the technical solutions of the embodiments of the present disclosure, the drawings required for the description of the embodiments are briefly introduced below. It should be apparent that the drawings described below are only some embodiments of the present disclosure. For those skilled in the art, other drawings can also be obtained according to these drawings without creative efforts. The described embodiments may be better understood by reference to the following description and the accompanying drawings, in which:

FIG. 1 is a perspective view of a transmitter optical subassembly according to a first embodiment of the present disclosure;

FIG. 2 is a perspective view of a TO package of the transmitter optical subassembly shown in FIG. 1;

FIG. 3 is a perspective view of the first substrate and the package structure of the transmitter optical subassembly shown in FIG. 2;

FIG. 4 is a schematic circuit structural diagram of a TO model integrated with the transmitter optical subassembly and an entire cascaded bias system for simulation;

FIG. 5 is a schematic diagram of simulation results of the TO model integrated with the transmitter optical subassembly and the entire cascaded bias system;

FIG. 6 is another perspective view of the transmitter optical subassembly shown in FIG. 1;

FIG. 7 is a schematic curve diagram illustrating the influence of a tuning resistor on a frequency response of the transmitter optical subassembly;

FIG. 8 is a schematic diagram of normalized frequency response results of the tuning resistor;

FIG. 9A is a schematic structural diagram of the side of the first substrate away from the first conductive pattern layer of the transmitter optical subassembly shown in FIG. 1;

FIG. 9B is a schematic structural diagram of a secondary column of the transmitter optical subassembly shown in FIG. 1, in which a slot is disposed on a side of a third bearing surface;

FIG. 10 is a schematic structural diagram of an optical module according to a second embodiment of the present disclosure; and

FIG. 11 is a schematic frequency response curve diagram corresponding to the optical module according to the second embodiment of the present disclosure.

FIG. 12 is a schematic structural diagram illustrates a planar spiral inductor element on a second substrate in another embodiment of the present disclosure.

### DETAILED DESCRIPTION OF THE EXEMPLARY EMBODIMENTS

The foregoing description is merely an overview of the technical solutions of the present disclosure. In order to more clearly understand the technical means of the present disclosure and to implement it according to the contents of the specification, and in order to make the above and other objects, features, and advantages of the present disclosure more apparent and understandable, preferred embodiments are exemplified below and described in detail in conjunction with the drawings.

In the description of the present disclosure, it should be understood that, unless otherwise clearly defined and limited, the terms “mounted,” “connected,” and “coupled” are to be broadly understood. For example, they may be fixed connections, detachable connections, or integrally formed connections; they may be mechanical connections, electrical connections, or communication connections; they may be directly connected or indirectly connected through an intermediate medium; they may be internal connections within two components, or interactions between two components. The term “chip” herein may include a bare chip. With respect to the sequence of method steps, the sequence shown in the drawings represents one exemplary scheme, but it is not intended to be a limitation of the sequence. For those skilled in the art, the above terms may be understood in the context of the present disclosure according to specific circumstances.

The terms “first” and “second” are used only for descriptive purposes and should not be construed as indicating or implying relative importance or implicitly specifying the number of the indicated technical features. Thus, features defined with “first” and “second” may explicitly or implicitly include at least one such feature. In the description of the present disclosure, the meaning of “plurality” is at least two, for example two, three, or more, unless otherwise specifically defined.

Unless otherwise defined, all technical and scientific terms used herein have the same meanings as those commonly understood by those skilled in the art to which the present disclosure pertains. The terms used in the specification of the present disclosure are only for the purpose of describing particular embodiments and are not intended to limit the present disclosure. The term “and/or” as used herein includes any and all combinations of one or more of the associated listed items.

In order to make the objects, features, and advantages of the present disclosure more apparent and understandable, the present disclosure is further described in detail below in conjunction with the drawings and specific embodiments.

### First Embodiment

The present embodiment provides a transmitter optical subassembly 100, which is configured to convert an RF signal into an optical signal and to emit the optical signal.

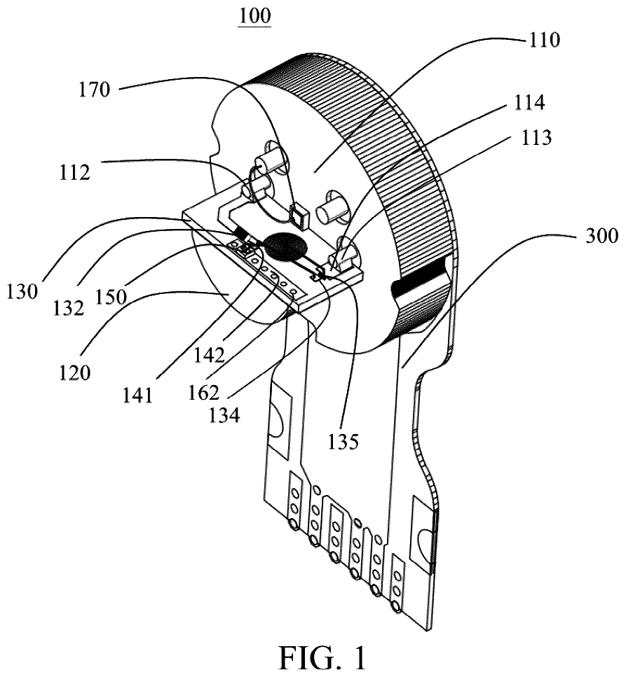

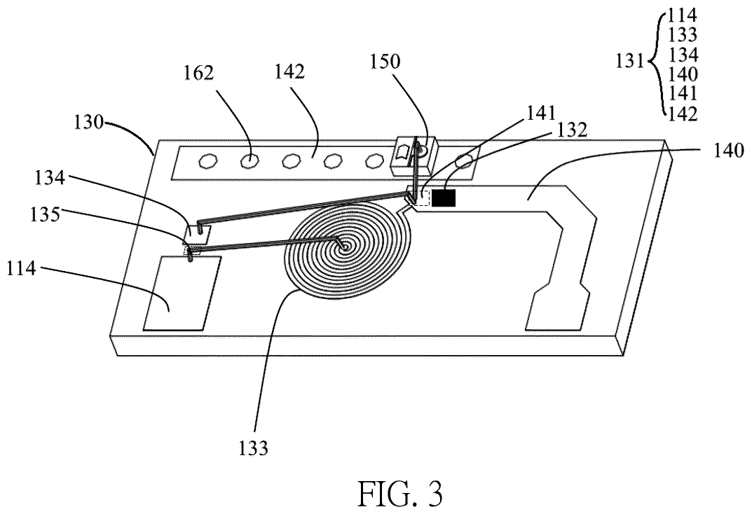

Referring to FIG. 1 to FIG. 3 and FIG. 6, the transmitter optical subassembly 100 of the present embodiment includes a core column 110, a secondary column 120, and a first substrate 130. The core column 110, the secondary column 120, and the first substrate 130 each have good heat dissipation performance, and the secondary column 120 serves as a heat sink between the core column 110 and the first substrate 130.

The core column 110 has a first bearing surface 110a and a second bearing surface 110b that are disposed opposite to each other. The core column 110 is connected with a ground signal pin 180, an RF signal input pin 112, and a bias signal input pin 113. The core column 110 and the secondary column 120 are grounded through the ground signal pin 180. Generally, the core column 110 can be perforated in its thickness direction to form corresponding through holes. The RF signal input pin 112 and the bias signal input pin 113 can respectively penetrate the core column 110 through individual through holes and extend out of the first bearing surface 110a of the core column 110. An insulating layer is commonly disposed on an inner wall of each through hole such that the RF signal input pin 112 remains insulated from the through hole, and the bias signal input pin 113 remains insulated from the through hole.

In the present embodiment, the RF signal input pin 112 is configured to input an RF signal, which can include a broadband RF signal. The bias signal input pin 113 is configured to input a bias signal, which can include a bias current signal.

The secondary column 120 protrudes from the first bearing surface 110a of the core column 110, and the secondary column 120 has a third bearing surface 1201. The third bearing surface 1201 forms an angle with the first bearing surface 110a. Preferably, the third bearing surface 1201 is perpendicular to the first bearing surface 110a.

The first substrate 130 is disposed on the third bearing surface 1201. The first substrate 130 is provided with a first conductive pattern layer 140, a transmitter optical chip 150, and a matching resistor 132. The first conductive pattern layer 140 includes an RF signal transmission line, a first pad 141, and a second pad 142. The transmitter optical chip 150 is electrically connected to the first pad 141 and the second pad 142. The second pad 142 serves as a ground pad. The matching resistor 132 is electrically connected to an RF signal transmission line and the first pad 141. By setting the matching resistor 132, the impedance discontinuity of the transmission link is reduced, thereby reducing reflection of the link signal and optimizing the gain flatness.

In some embodiments, a monitor photodetector (MPD) 170 can be disposed on the first bearing surface 110a of the core column 110. The MPD 170 is located beneath a backlight direction of the transmitter optical chip 150, serving as a backlight detector of the transmitter optical chip 150 to monitor the light output condition of the transmitter optical chip 150. When the third bearing surface 1201 is perpendicular to the first bearing surface 110a, a light-emitting end face of the transmitter optical chip 150 faces upward and directly outputs an optical signal in a direction perpendicular to the first bearing surface of the core column 110. The optical path is thereby simplified, which facilitates optical coupling with external devices.

The transmitter optical subassembly 100 provided in the present embodiment further comprises a first-stage bias device 133. One end of the first-stage bias device 133 is electrically connected to the first pad 141, and another end of the first-stage bias device 133 is electrically connected to the bias signal input pin 113. The first pad 141 serves as the connection point between the first-stage bias device 133 and the transmitter optical chip 150, such that one end of the matching resistor 132 is electrically connected to the connection point between the first-stage bias device 133 and the transmitter optical chip 150, and another end of the matching resistor 132 is electrically connected to the RF signal input pin 112. The RF signal and the bias signal are respectively transmitted to the transmitter optical chip 150 through the first pad 141, such that the RF signal is converted into an optical signal under the action of the bias signal, and the optical signal is emitted.

Exemplarily, in some embodiments, the first-stage bias device 133 and the transmitter optical chip 150 are both disposed on the first substrate 130. Alternatively, in other embodiments, the first-stage bias device 133 can also be disposed on another substrate, for example, a substrate separate from that on which the transmitter optical chip 150 and the matching resistor 132 are disposed.

The technical solution provided in the present embodiment is intended to optimize the electrical interface reflection of radio-on-fiber (ROF) transmission to achieve optimal impedance matching by disposing the first conductive pattern layer, the transmitter optical chip 150, and the matching resistor 132 on the first substrate 130. The first conductive pattern layer includes an RF signal transmission line, the first pad 141, and the second pad 142, and both the matching resistor 132 and the first pad 141 are disposed adjacent to the transmitter optical chip 150. In this way, the distance between the matching resistor 132 and the transmitter optical chip 150 is minimized, thereby reducing link signal reflection, optimizing gain flatness, and improving the transmission performance of the RF signal. At the same time, the solution is more suitable for Transistor-Outline (TO) packaging.

In some embodiments, the secondary column 120 and the core column 110 are formed as an integral metal structure. An angle is included between the third bearing surface 1201 and the first bearing surface 110a. Preferably, the third bearing surface 1201 is perpendicular to the first bearing surface 110a.

In some embodiments, the first substrate 130 disposed inside the TO package adopts a ceramic substrate. The ceramic substrate can, for example, include AlN material. Compared with other ceramic materials, AlN exhibits better thermal conductivity, so that the first substrate 130 has better heat dissipation performance and low insertion loss. In addition, the first substrate 130 can be fixedly connected to the third bearing surface 1201 by bonding or other means.

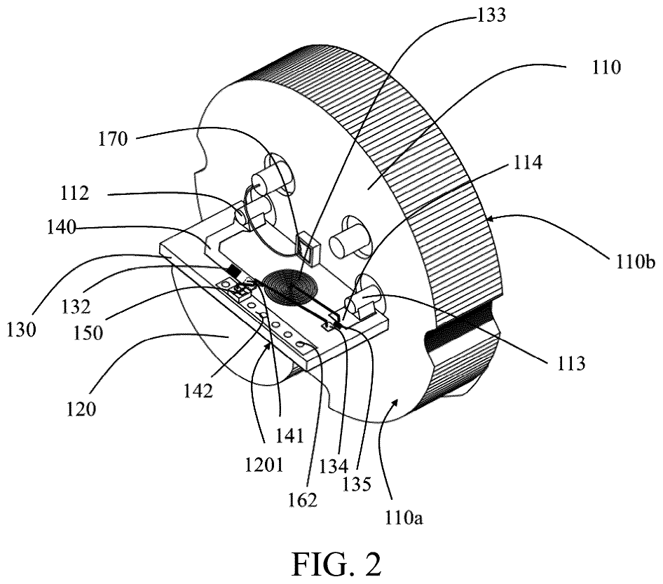

Exemplarily, in the present embodiment, the transmitter optical chip 150 includes a laser chip (i.e., a laser diode). The laser diode is a directly modulated laser chip, such as a DFB chip, having relatively low power consumption and reduced heat dissipation. The transmitter optical chip 150 includes a first electrode and a second electrode, where the first electrode is the anode of the laser diode and the second electrode is the cathode of the laser diode. The transmitter optical chip 150 can further include other laser emission devices capable of performing electrical-to-optical conversion. Specifically, the first electrode of the transmitter optical chip 150 is electrically connected to the first pad 141 by wire bonding. The second electrode of the transmitter optical chip 150 is grounded. Exemplarily, as shown in FIG. 2, a plurality of conductive vias 162 (e.g., metallized drilled holes filled with metal) are formed on the first substrate 130. The second pad 142 is electrically connected to a reference ground layer disposed on a side of the first substrate 130 away from the first conductive pattern layer through the plurality of conductive vias 162. The transmitter optical chip 150 is electrically connected to the second pad 142 through the backside ground electrode thereof (i.e., the second electrode).

Specifically, in the present embodiment, the secondary column 120 can be a heat-dissipating secondary column. Heat generated during operation of the laser chip is conducted through the first substrate 130 (e.g., adopting the ceramic substrate having good thermal conductivity) to the secondary column 120, which acts as a heat sink, then conducted to the core column 110, and further conducted to the housing of the optical module through the core column 110 for heat dissipation.

Therefore, by adopting the technical solution of the present embodiment, an additional thermoelectric cooling device is not required to be disposed between the first substrate 130 and the third bearing surface 1201 of the secondary column 120. As a result, the problem of increased power consumption caused by the presence of a thermoelectric cooling device is avoided, and the overall manufacturing cost of the transmitter optical subassembly is also reduced.

In the present embodiment, since the distance between the matching resistor 132 and the transmitter optical chip 150 is compressed, higher requirements are imposed on the size and layout of the RF chokes. If a conventional bead inductor is adopted as the first-stage bias device, due to the limitation of the package volume, the distance between the matching resistor 132 and the transmitter optical chip 150 cannot be sufficiently reduced. In addition, the electrodes of a conventional bead inductor adopt a tin-plating process, which makes it difficult to reliably solder the bead inductor to ceramic devices inside the TO package.

Further, a planar spiral inductor element is adopted as the first-stage bias device 133, which is connected to the first pad 141, serving as a choke to block RF signals from the RF signal transmission link, while allowing the bias signal to be transmitted through the spiral inductor to the transmitter optical chip 150. By fabricating the first-stage bias device 133 (e.g., a high-frequency inductor) as a planar spiral inductor, the distance between the matching resistor 132 and the transmitter optical chip 150 can be minimized, thereby further reducing reflection of the transmission link signal. Compared with a conventional bead inductor whose electrodes using a tin-plating process are difficult to reliably solder to ceramic devices inside the TO package, the planar spiral inductor element provided in the present embodiment is easier to solder or integrate with ceramic devices inside the TO package, and therefore has relatively higher reliability.

Exemplarily, in order to increase integration density, a first conductive film layer (not shown) can be formed on the first substrate 130, such as a conductive metal film layer, and the first conductive film layer can then be patterned and etched to form the first conductive pattern layer 131. Part of the first conductive pattern layer 131 forms the RF signal transmission line 140, the first pad 141, and the second pad 142, and another part of the first conductive pattern layer 131 forms the planar spiral inductor element and other wire-bonding pads. That is, the first conductive pattern layer 131 disposed on the first substrate 130 includes a portion that forms the planar spiral inductor element.

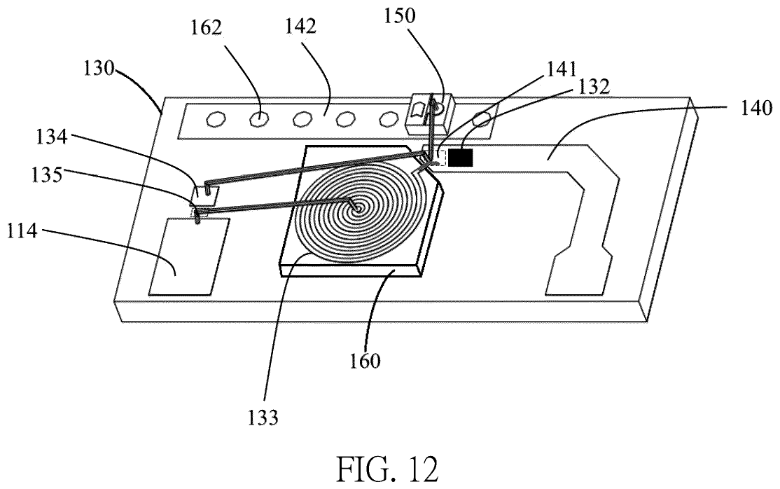

Alternatively, in other embodiments, as shown in FIG. 12, the transmitter optical subassembly 100 further comprises a second substrate 160 disposed on a side of the core column 110 with the first bearing surface 110a. The second substrate 160 includes a second conductive pattern layer, and the planar spiral inductor element is formed by a portion of the second conductive pattern layer. In some embodiments, the second substrate 160 is disposed on the first substrate 130. The planar spiral inductor element is electrically connected to the first pad 141 and the bias signal input pin 113 through bonding wires.

Further, the planar spiral inductor element has a predetermined number of turns and a predetermined line width. For example, assuming that each spiral inductor has the same line width in a direction from its center outward and that the gaps between adjacent spiral inductors are equal, the corresponding number of coil turns can be obtained through simulation calculation based on the ideal inductive biasing effect. Alternatively, the inductance value that can be achieved with the planar spiral inductor element at a predetermined number of turns can be simulated, so as to more effectively function as a choke to block RF signals from the RF signal transmission line.

In the present embodiment, a bias signal input pad 114 is disposed on the first substrate 130, and the bias signal input pin 113 is electrically connected to the bias signal input pad 114. For example, the connection can be made by AuSn soldering or wire bonding. Exemplarily, a central end portion at the center of the planar spiral inductor element is electrically connected to the bias signal input pad 114 by wire bonding (i.e., a bonding wire), to be electrically connected to the bias signal input pin 113. In some embodiments, the central end portion can also be directly electrically connected to the bias signal input pin 113 by a bonding wire, that is, a wire is bonded directly between the central end portion and the bias signal input pin 113. An outer end portion located at the outer periphery of the planar spiral inductor element is directly interconnected with the first pad 141 by the first conductive pattern layer, that is, the outer peripheral end portion is directly connected to the first pad 141.

A tuning resistor 135 is further disposed on the first substrate 130. One end of the tuning resistor 135 is electrically connected to the bias signal input pad 114, and another end of the tuning resistor 135 is electrically connected to a wire-bonding pad 134. The wire-bonding pad 134 is electrically connected to the first pad 141 through wire bonding, so as to achieve electrical connection between the tuning resistor 135 and the first pad 141. Specifically, the two ends of the tuning resistor 135 are electrically connected between the wire-bonding pad 134 and the bias signal input pad 114.

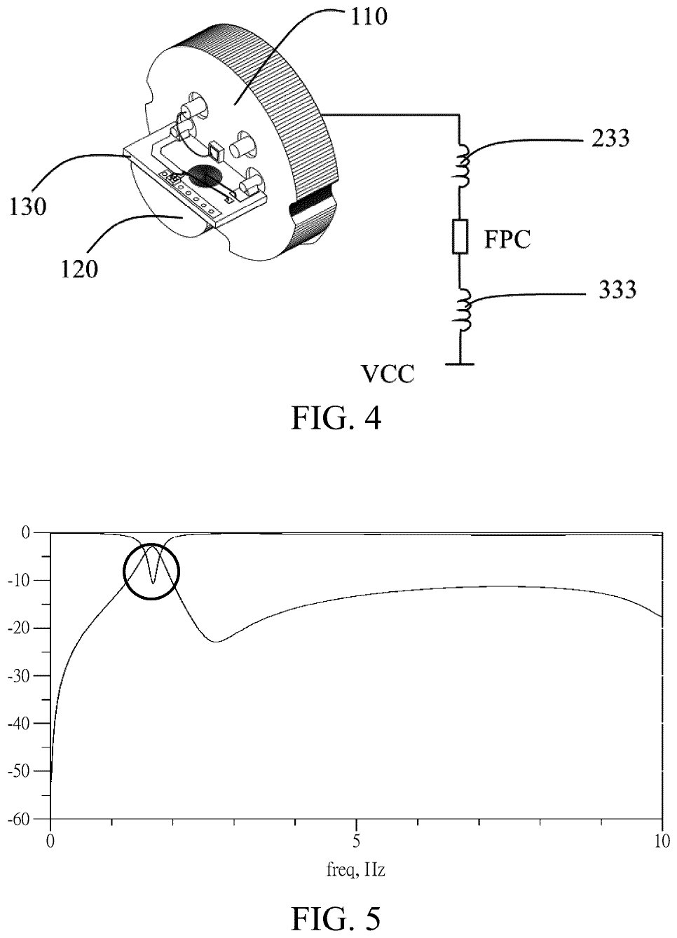

FIG. 4 illustrates a circuit structure diagram of a TO model integrated with the transmitter optical subassembly and the entire cascaded bias system for simulation, and FIG. 5 illustrates a result diagram of the TO model integrated with the transmitter optical subassembly and the entire cascaded bias system for simulation.

As shown in FIG. 4, in the present embodiment, the transmitter optical subassembly further comprises a second-stage bias device 233, and the second-stage bias device 233 is cascaded with the first-stage bias device 133.

Table 1 shows the corresponding guided wavelengths at different frequencies based on a ceramic substrate.

TABLE 1_sm_0001

| Frequency | Guided Wavelength |
|---|---|
| 10 G | 10.1 |
| 9 G | 11.22 |
| 8 G | 12.63 |
| 7 G | 14.43 |
| 6 G | 16.84 |
| 5 G | 20.21 |
| 4 G | 25.26 |
| 3 G | 33.68 |
| 2 G | 50.53 |
| 1 G | 101.06 |

Generally, as shown in Table 1, in order to enable the distributed parameter effect introduced by the transmission line to be sufficiently small, the guided wavelength corresponding to the frequency must be much longer than the electrical length of the transmission line. A ratio of 10 times is adopted herein. By comparing with the table above, it can be seen that ideally, the high-frequency cutoff of the second-stage bias device 233 must be higher than 2 GHz.

Similarly, in order to prevent anti-resonance caused by a mismatch between the low-frequency cutoff and the high-frequency cutoff of the first-stage bias device and the second-stage bias device, the low-frequency cutoff of the first-stage bias device is required to be less than 2 GHz.

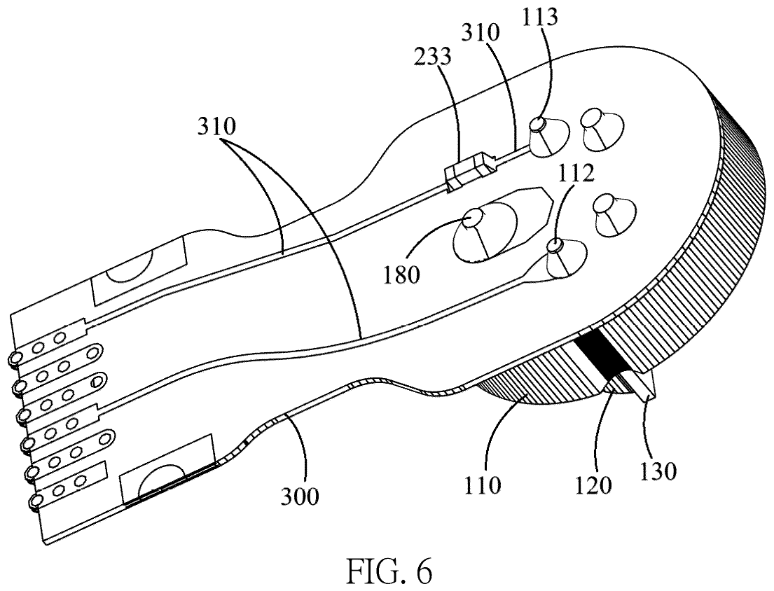

Specifically, as shown in FIG. 6, the transmitter optical subassembly further comprises a flexible printed circuit board 300 (FPC). The flexible printed circuit board 300 is located on a side of the second bearing surface 110b of the core column 110, and the flexible printed circuit board 300 is electrically connected to the RF signal input pin 112 and the bias signal input pin 113, respectively. The second-stage bias device 233 is disposed on the flexible printed circuit board 300, and the second-stage bias device 233 is cascaded with the first-stage bias device 133 through the trace 310 of the flexible printed circuit board 300 and the bias signal input pin 113. The second-stage bias device 233 serves as a medium-frequency inductor to compensate for the low-frequency cutoff of the first-stage bias device 133 (a high-frequency inductor), thereby expanding the low-frequency coverage range, optimizing the amplitude-frequency characteristic, reducing manufacturing cost, and improving reliability. In FIG. 6, a ground signal pin 180 is further shown in the middle portion of the flexible printed circuit board 300. Specifically, the core column 110 and the secondary column 120 are grounded through the ground signal pin 180.

As shown in FIG. 5, the simulation results indicate that, compared with the ideal case, the actual bias devices, due to parasitic effects and the electrical length of the second-stage bias device 233, cause an anti-resonance point between the low-frequency cutoff of the first-stage bias device 133 and the high-frequency cutoff of the second-stage bias device 233 (corresponding to the circled position in the figure).

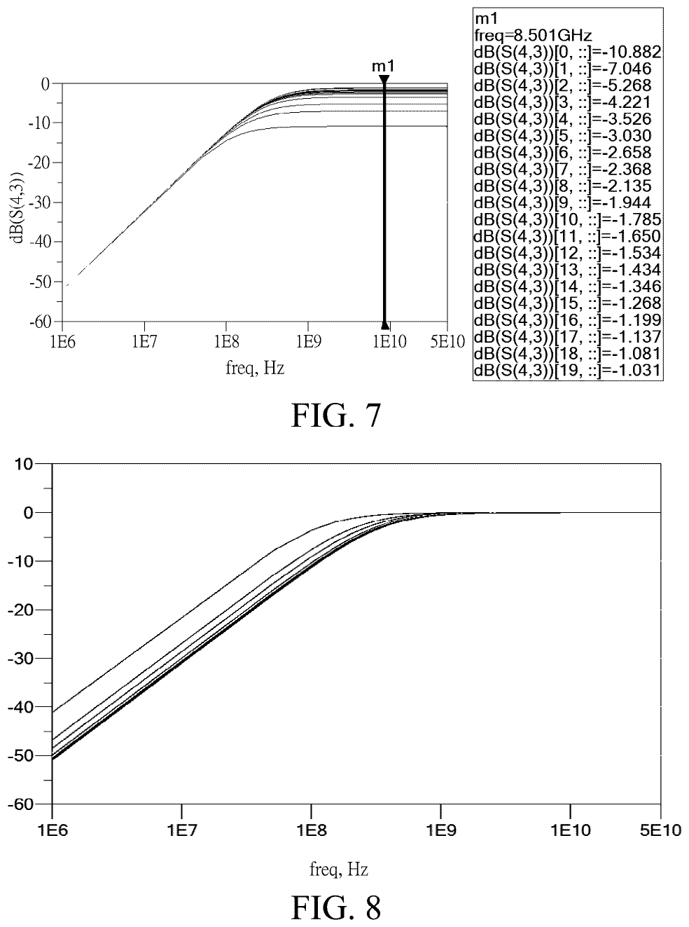

In order to overcome the above-mentioned anti-resonance problem, in the present embodiment, a tuning resistor 135 is further disposed on the first substrate 130. The tuning resistor 135 is connected in parallel with the first-stage bias device 133, and the tuning resistor 135 has a predetermined resistance value. FIG. 7 illustrates a curve diagram showing the effect of the tuning resistor 135 on the frequency response of the optical emission module, and FIG. 8 illustrates a normalized result diagram of the frequency response of the tuning resistor 135. Verification in FIG. 8 indicates that tuning resistors with different resistance values have a certain influence on the frequency-domain response of the optical emission module.

Specifically, one end of the tuning resistor 135 is electrically connected to a wire-bonding pad 134, which is further electrically connected to the first pad 141 by wire bonding to achieve electrical connection between the tuning resistor 135 and the first pad 141. Another end of the tuning resistor 135 is electrically connected to the bias signal input pad 114, and further electrically connected to the bias signal input pin 113, so that the tuning resistor 135 is connected in parallel with the planar spiral inductor element. By using the tuning resistor 135 to compensate for the anti-resonance between the first-stage bias device and the second-stage bias device, the gain flatness within the frequency band is optimized. At the same time, by adopting wire bonding, high-frequency isolation is achieved, so that both tuning and link signal reflection optimization can be realized in a unified manner.

It should be noted that when a tuning resistor 135 is connected in parallel to the first-stage bias device 133, although the insertion loss of the optical emission module is affected to some extent, the gain across the entire passband also changes linearly. As shown in FIG. 8, after normalizing the gain, the low-frequency cutoff is expanded. This demonstrates that by adding at least one tuning resistor in parallel, the circuit with the additional second-stage bias device can be tuned. According to the resonance peak and the cutoff frequencies of the first-stage bias device and the second-stage bias device, the resistance value of the tuning resistor is typically in the range of 50-200 ohms (Ω).

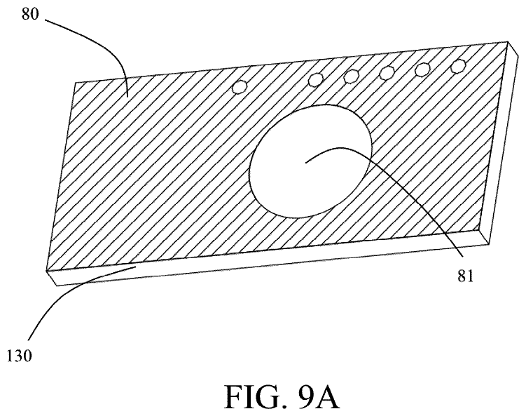

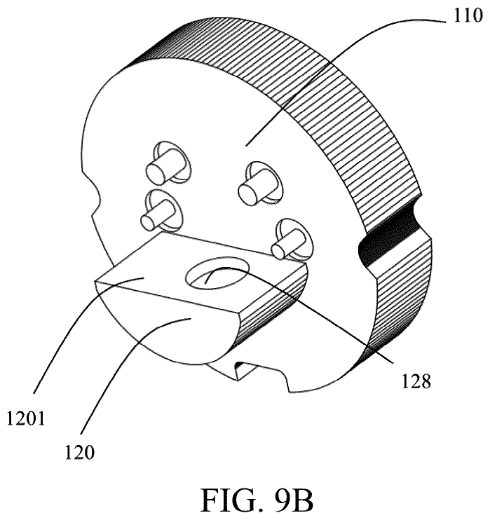

FIG. 9A illustrates the structure of the side of the first substrate 130 away from the first conductive pattern layer of the transmitter optical subassembly shown in FIG. 1. FIG. 9B illustrates a schematic structural diagram of the secondary column 120 of the transmitter optical subassembly shown in FIG. 1, in which a slot is disposed on a side of the third bearing surface 1201.

Referring to FIG. 9A and FIG. 9B, exemplarily, a reference ground layer 80 is disposed over the entire surface of the side of the first substrate 130 away from the first conductive pattern layer. An aperture 81 is formed in the reference ground layer 80. Exemplarily, the reference ground layer 80 is a copper layer, and the copper layer at the position corresponding to the planar spiral inductor element is removed to form the aperture 81. The secondary column 120 has a slot 128 on a side of the third bearing surface 1201. In the thickness direction of the first substrate 130, the projection of the planar spiral inductor element falls within the projection range of the aperture 81 as well as within the projection range of the slot 128. That is, the third bearing surface 1201 of the secondary column 120 is subjected to slotting (or hole-digging, perforating) treatment with a certain depth, so as to reduce coupling between the planar spiral inductor element and the ground, increase the mutual inductance among turns of the planar spiral inductor, and improve the Q value.

### Second Embodiment

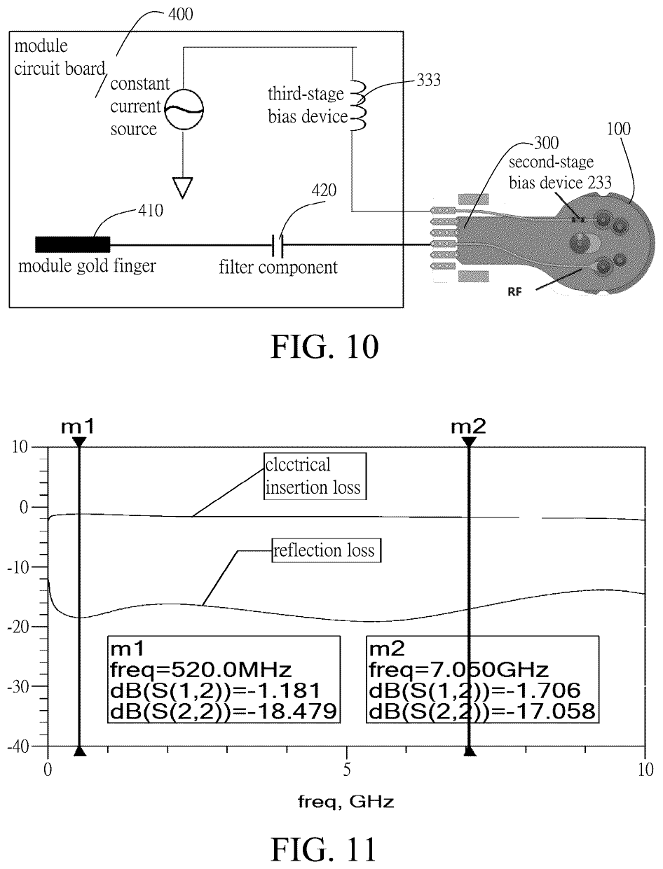

FIG. 10 illustrates a schematic structural diagram of an optical module provided in the second embodiment of the present disclosure.

Referring to FIG. 10, the present embodiment provides an optical module, which includes the transmitter optical subassembly 100 as provided in the first embodiment. For detailed description of the transmitter optical subassembly 100, reference can be made to the relevant disclosure of first embodiment, and repetition thereof is omitted herein.

The optical module includes a module circuit board 400. The module circuit board 400 is electrically connected to the transmitter optical subassembly 100 through the flexible printed circuit board (FPC) 300. The optical module can further comprise an optical interface (not shown), which is connected with an external optical fiber connector and is configured to receive and transmit optical signals.

Further, the optical module also includes a third-stage bias device 333. The third-stage bias device 333 is disposed on the module circuit board 400. The second-stage bias device 233 is disposed on the flexible printed circuit board 300. The third-stage bias device 333 is electrically connected between the flexible printed circuit board 300 and a constant current source. A bias signal is transmitted from the constant current source sequentially through the third-stage bias device 333, the second-stage bias device 233, the bias signal input pin 113, and the first-stage bias device 133, and then delivered to the transmitter optical chip.

Further, the optical module also includes a filter component 420. The filter component 420 is disposed in the RF signal transmission link on the module circuit board 400. One end of the filter component 420 is electrically connected to gold fingers 410 on the module circuit board 400. The filter component 420 is configured to block direct current noise in the RF signal transmission link and transmit alternating current RF signals. The alternating current RF signals are transmitted via the flexible printed circuit board 300 and the RF signal input pin 112 to the RF signal transmission line on the first substrate 130, and further transmitted to the transmitter optical chip through the matching resistor 132.

Optionally, the filter component 420 includes at least one capacitor, serving as a DC-blocking capacitor to isolate external interference DC signals.

FIG. 11 illustrates a frequency response curve diagram corresponding to the optical module provided in the second embodiment of the present disclosure.

As shown in FIG. 11, by adopting the technical solution of the present embodiment, the optimized passband achieves low reflection loss, and the coverage range of the passband has a margin greater than 9 GHz. In addition, the frequency response within the passband is flat without resonance anomalies, thereby meeting the bandwidth requirements of ROF transmission: the passband requires a low-frequency cutoff of 1 MHz, a high-frequency cutoff of 8 GHz, and the reflection loss of the link signal is less than −8 dB across the full band.

The present disclosure provides a solution for optimizing the electrical interface reflection of the ROF transmission of the transmitter optical subassembly. The transmitter optical subassembly includes the core column, the secondary column, and the first substrate. By disposing a first conductive pattern layer, a transmitter optical chip, and a matching resistor on the first substrate, where the first conductive pattern layer includes an RF signal transmission line, a first pad, and a second pad, the transmitter optical chip is electrically connected to the first pad and the second pad, the second pad 142 serves as a ground pad, and the matching resistor is electrically connected between the RF signal transmission line and the first pad. Both the matching resistor and the first pad are disposed adjacent to the transmitter optical chip. In this way, the distance between the matching resistor and the transmitter optical chip is reduced, thereby optimizing the electrical interface reflection of ROF transmission to achieve optimal impedance matching, reducing link signal reflection, optimizing gain flatness, and improving the transmission performance of the RF signal. At the same time, the solution is more suitable for Transistor-Outline (TO) packaging.

Furthermore, in order to expand the coverage range of the passband and improve the flatness of the frequency response within the passband, a second-stage bias device and a third-stage bias device are cascaded with the first-stage bias device, and a tuning resistor is connected in parallel with the first-stage bias device. The tuning resistor is used to compensate for the anti-resonance between the first-stage bias device and the second-stage bias device, thereby optimizing the gain flatness within the passband. Meanwhile, wire bonding is adopted to achieve high-frequency isolation, enabling unified realization of both tuning and link signal reflection optimization.

The foregoing description only illustrates the preferred embodiments of the present disclosure and is not intended to limit the scope of implementation of the present disclosure. Any equivalent variations and modifications made according to the shape, structure, features, and spirit described in the claims of the present disclosure shall be included within the scope of protection of the present disclosure.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A transmitter optical subassembly, comprising:
a core column provided with a first bearing surface and a second bearing surface disposed opposite to each other, the core column being connected with an RF signal input pin and a bias signal input pin;
a secondary column protruding from the first bearing surface of the core column, the secondary column being provided with a third bearing surface;
a first substrate disposed on the third bearing surface, the first substrate being provided with a first conductive pattern layer, a transmitter optical chip, and a matching resistor; the first conductive pattern layer including an RF signal transmission line, a first pad, and a second pad; the transmitter optical chip being electrically connected to the first pad and the second pad respectively, the second pad serving as a ground pad, and the matching resistor being electrically connected to the RF signal transmission line and the first pad respectively; and the matching resistor and the first pad being disposed adjacent to the transmitter optical chip; and
a first-stage bias device having one end electrically connected to the first pad and another end electrically connected to the bias signal input pin.

2. The transmitter optical subassembly according to claim 1, wherein the first-stage bias device is a planar spiral inductor element.

3. The transmitter optical subassembly according to claim 2, wherein the planar spiral inductor element is formed by a portion of the first conductive pattern layer; or the transmitter optical subassembly further comprises a second substrate disposed on a side of the core column with the first bearing surface, the second substrate includes a second conductive pattern layer, and the planar spiral inductor element is formed by a portion of the second conductive pattern layer.

4. The transmitter optical subassembly according to claim 3, wherein the second substrate is disposed on the first substrate.

5. The transmitter optical subassembly according to claim 3, wherein the planar spiral inductor element has a predetermined number of turns and a predetermined line width.

6. The transmitter optical subassembly according to claim 2, wherein an end portion at a center of the planar spiral inductor element is electrically connected to the bias signal input pin by a bonding wire; or
the first conductive pattern further comprises a bias signal input pad, wherein the end portion at the center of the planar spiral inductor element is electrically connected to the bias signal input pad by a bonding wire; and
an end portion at the outer periphery of the planar spiral inductor element is directly connected to the first pad by an interconnection structure form by the first conductive pattern layer.

7. The transmitter optical subassembly according to claim 1, further comprising: a flexible printed circuit board located on a side of the second bearing surface of the core column, the flexible printed circuit board being electrically connected to the RF signal input pin and the bias signal input pin, respectively; and
a second-stage bias device disposed on the flexible printed circuit board, the second-stage bias device being cascaded with the first-stage bias device through the trace of the flexible printed circuit board and the bias signal input pin.

8. The transmitter optical subassembly according to claim 7, wherein the second-stage bias device is located on the side of the flexible printed circuit board facing away from the core column and adjacent to the position of the bias signal input pin.

9. The transmitter optical subassembly according to claim 1, further comprising a tuning resistor, wherein the tuning resistor is connected in parallel with the first-stage bias device, and the tuning resistor has a predetermined resistance value.

10. The transmitter optical subassembly according to claim 9, wherein one end of the tuning resistor is electrically connected to the first pad through a bonding wire, and another end of the tuning resistor is electrically connected to the bias signal input pin.

11. The transmitter optical subassembly according to claim 2, wherein a reference ground layer is disposed on a surface of the first substrate away from the first conductive pattern layer, and wherein the reference ground layer has an aperture, and a slot is provided on a side of the secondary column with the third bearing surface;
wherein, in a thickness direction of the first substrate, a projection of the planar spiral inductor element falls within a projection range of the aperture and within a projection range of the slot.

12. The transmitter optical subassembly according to claim 11, wherein the secondary column and the core column are formed as an integral metal structure, an angle is formed between the third bearing surface and the first bearing surface, the second pad is electrically connected to the reference ground layer, and the reference ground layer is electrically connected to the secondary column.

13. The transmitter optical subassembly according to claim 1, wherein the first substrate is a ceramic substrate.

14. The transmitter optical subassembly according to claim 11, wherein the second pad is electrically connected to the reference ground layer through a plurality of conductive vias, and the transmitter optical chip is electrically connected to the second pad through a backside ground electrode thereof.

15. The transmitter optical subassembly according to claim 1, wherein the transmitter optical subassembly is a TO-can package.

16. An optical module, comprising:
the transmitter optical subassembly according to claim 1; and
a module circuit board electrically connected to the transmitter optical subassembly through a flexible printed circuit board.

17. The optical module according to claim 16, further comprising a third-stage bias device, wherein the third-stage bias device is disposed on the module circuit board, a second-stage bias device is disposed on the flexible printed circuit board, and the third-stage bias device is electrically connected between the flexible printed circuit board and a constant current source, so that a bias signal is transmitted from the constant current source sequentially through the third-stage bias device, the second-stage bias device, the bias signal input pin, and the first-stage bias device, and then delivered to the transmitter optical chip.

18. The optical module according to claim 17, further comprising a DC-block, wherein the filter component is disposed in an RF signal transmission link on the module circuit board, the filter component being configured to block direct current noise in the RF signal transmission link so as to transmit alternating current RF signals, the alternating current RF signals being transmitted via the flexible printed circuit board and the RF signal input pin to the RF signal transmission line on the first substrate, and further transmitted to the transmitter optical chip through the matching resistor.

19. The optical module according to claim 18, wherein the filter component includes at least one capacitor.
